(19) United States
(12) Patent Application Publication
(10) Pub. No.: US 2025/0242586 A1
(43) Pub. Date: Jul. 31, 2025

(54) PRINTING FLUID EJECTION ASSEMBLIES

(71) Applicant: Hewlett-Packard Development Company, L.P., Spring, TX (US)

(72) Inventors: Garrett E. CLARK, Corvallis, OR (US); Jacob LUM, Corvallis, OR (US)

(73) Assignee: Hewlett-Packard Development Company, L.P., Spring, TX (US)

(21) Appl. No.: 18/726,404

(22) PCT Filed: Jan. 28, 2022
(86) PCT No.: PCT/US2022/014333

§ 371 Date: Jul. 2, 2024

(51) Int. Cl. B41J 2/14

(52) U.S. Cl. CPC B41J 2/14; B41J 2002/14419

(57) ABSTRACT

According to an example, a printing fluid ejection assembly comprises a first printing fluid channel including an inlet, an outlet, and a first printing fluid ejection element, a second printing fluid channel comprising an actuator in fluidic communication with the first printing fluid channel, and a nozzle layer comprising a first nozzle arranged to correspond to the first printing fluid ejection member. The actuator, in response to reception of refresh signals, is to fire and refresh printing fluid in a first nozzle meniscus region.

### BACKGROUND

Printing systems comprise printing fluid ejection assemblies to provide drop-on-demand ejection of printing fluid droplets. In general, printing systems print images by ejecting printing fluid droplets through a plurality of nozzles onto a printing medium (for instance, a sheet of paper or a layer of build material)

### BRIEF DESCRIPTION OF DRAWINGS

Features of the present disclosure are illustrated by way of example and are not limited in the following figure(s), in which like numerals indicate like elements, in which:

FIG. 1 shows a side view of a printing fluid ejection assembly, according to an example of the present disclosure;

FIG. 2A shows a top view of a printing fluid ejection assembly comprising a first printing fluid channel and a second printing fluid channel, according to an example of the present disclosure;

FIG. 2B shows a top view of a printing fluid ejection assembly comprising a second printing fluid channel substantially orthogonal to a first printing fluid channel, according to an example of the present disclosure;

FIG. 2C shows a top view of a printing fluid ejection assembly comprising a first printing fluid channel in fluidic communication with a second printing fluid channel via an inlet region and an outlet region, according to an example of the present disclosure,

FIG. 2D shows a top view of a printing fluid ejection assembly comprising a first printing fluid channel, a second printing fluid channel, and a third printing fluid channel, according to an example of the present disclosure;

FIG. 2E shows a top view of a printing fluid ejection assembly comprising a first printing fluid channel, a second printing fluid channel having a closed-end, and a third printing fluid channel, according to an example of the present disclosure;

FIG. 2F shows a top view of a printing fluid ejection assembly comprising a first printing fluid channel and a third printing fluid channel in fluidic communication with a second printing fluid channel via parallel channels, according to an example of the present disclosure;

FIG. 2G shows a top view of a printing fluid ejection assembly comprising a first printing fluid channel and a third printing fluid channel in fluidic communication with a second printing fluid channel via a series of channels, according to an example of the present disclosure;

FIG. 3 shows a method for refreshing a nozzle meniscus region of a printing fluid ejection assembly, according to an example of the present disclosure;

FIG. 4 shows a method for refreshing a nozzle meniscus region in response to exceeding a threshold idle time, according to an example of the present disclosure,

FIG. 5 shows a printing fluid ejection assembly comprising a series of layers stacked on each other, according to an example of the present disclosure.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent, however, that the present disclosure may be practiced without limitation to these specific details. In other instances, some methods and structures have not been described in detail so as not to unnecessarily obscure the present disclosure

Throughout the present disclosure, the terms “a” and “an” are intended to denote at least one of a particular element. Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more.” “at least,” and/or other similar terms may be used in an abundance of caution (and without limiting the interpretation of other terms) to describe any feature, structure, characteristic, and/or the like in the singular, “and/or” is also used to describe a plurality and/or some other combination of features, structures, characteristics, and/or the like. As used herein, the term “includes” means includes but not limited to, the term “including” means including but not limited to. The term “based on” means based at least in part on.

Printing systems use printing fluid ejection devices to provide drop-on-demand ejection of printing fluid in the form of printing fluid droplets. By subsequently ejecting printing fluid droplets, printing systems print images onto a printing medium (such as a sheet of media or a layer of build material). To dispense the printing fluid droplets, the printing fluid ejection devices comprise a plurality of nozzles arranged in one or more arrays.

To provide drop-on-demand ejection, different types of printing fluid ejection devices may be used. In an example, the printing fluid ejection device may correspond to a thermal inkjet printhead that ejects printing fluid droplets by driving electrical current through a heating element of the printing fluid ejection device whereby the electrical current causes the heating element to generate heat. The heat generated by the heating element causes a small portion of printing fluid located nearby the heating element to vaporize such that a bubble is generated. As the printing fluid vaporizes, the bubble expands thereby causing an amount of printing fluid located at a nozzle meniscus region to be ejected through a nozzle of the printing fluid ejection device. In other examples, the printing fluid ejection device may correspond to a piezoelectric inkjet printhead that ejects printing fluid through a nozzle by generating pressure pulses with a piezoelectric actuator. The pressure pulses generated by the piezoelectric actuator exert a force to the printing fluid that causes printing fluid located at the nozzle meniscus region to be ejected out of the nozzle of the fluid ejection device.

As used herein, “printing fluid” refers generally to any substance that can be applied upon a substrate by a printing system during a printing operation, including but not limited to inks, primers, fusing agents, overcoat materials (such as a varnish), water, and solvents other than water.

Throughout the description, the term “meniscus region” will be used to refer to a volume of a printing fluid channel defined by a printing fluid ejection element, a nozzle, and a meniscus associated with the nozzle. When having multiple nozzles, multiple meniscus regions are defined. Also, as used herein, the term “meniscus” should be understood as an amount of printing fluid within a nozzle that is contact with the ambient environment. For instance, the meniscus may be a layer of printing fluid that separates printing fluid within the nozzle of the printing fluid ejection assembly from a region outside the printing fluid channel (such as a capping station or ambient air).

Improving the image print quality of printing systems typically involves addressing technical challenges that can reduce image print quality. Examples of such challenges comprise pigment settling or pigment-printing fluid vehicle separation (when using pigment-based printing fluids), air accumulation, or particle accumulation within printing fluid ejection elements.

In an example, the performance of a printing fluid ejection device may be adversely affected by air bubbles. In some examples, air bubbles may come from a printing fluid supply in fluidic communication with the fluid ejection device In other examples, air bubbles may appear as a result of air ingestion in the printing fluid ejection device. In some other examples, during a printing operation, the printing fluid may release air thereby forming air bubbles within a firing chamber of the printing fluid ejection device. Among others, air bubbles may result in blockage of a printing fluid channel of the printhead, partly full print supplies to be considered as empty, or printing fluid leaks (for instance, printhead drooling).

Also, the performance of printing fluid ejection devices may be adversely affected by pigment-ink vehicle separation (PIVS). For instance, when using pigment-based printing fluids, the pigment particles may settle or crash out the printing fluid vehicle, may also degrade the print quality. As a result, the PIVS may partially or completely block printing fluid flow towards a nozzle (or nozzles) in the printing fluid ejection device. In an example, pigment particles may settle or crash out of the printing fluid vehicle during excessive periods of storage or non-use.

In other examples, the performance of a printing fluid ejection device may be affected by the type of printing fluid being used by the printing system. In some examples, some of the mechanical properties of the printing fluid (such as the printing fluid viscosity) may change over time, thereby leading to negative impacts on the performance of the fluid ejection device.

Another factor that may adversely affect the performance of a fluid ejection device is an idle time in which a nozzle (or nozzles) remains uncovered and without ejecting printing fluid. In some examples, excessive idle times for a nozzle may alter drop ejection trajectories, velocities, shapes, and colors. In some examples, excessive idle times may result in nozzles of the fluid ejection device partly or fully clogged.

As used herein, the term “decap time” will be used to refer to time in which a nozzle of a printing fluid ejection device is idle (i.e., without performing a printing fluid ejection operation) while being uncapped and exposed to ambient environments If the decap time of the nozzle exceeds a threshold decap time, the nozzle (or nozzles) may experience at least one of the negative impacts previously explained Therefore, to reliably perform printing operations with a printing fluid ejection device while obtaining admissible levels of print quality, decap times of the nozzles have to be lower than the threshold decap time.

To overcome the above-mentioned technical challenges associated with excessive decap time, printing systems may have to perform printing fluid servicing operations. However, to implement such operations, additional elements may have to be used or printing fluid may be wasted, thereby increasing the cost and/or the size of the printing system. In some examples, servicing operations may comprise at least one of spitting printing fluid and wiping the printing fluid ejection elements.

In the following, printing fluid ejection elements with improved decap performance will be described. Accordingly, printing systems and methods are also described.

Printing fluid ejection devices such as printheads may comprise nozzles in fluidic communication with printing fluid chambers in which printing fluid is stored. To expel printing fluid from a printing fluid chamber through at least a nozzle of a printing fluid ejection device, the printing fluid chamber may comprise a printing fluid ejection element. Examples of printing fluid ejection elements comprise thermal-based ejection elements (for instance, a heat transducer to selectively heat printing fluid in the printing fluid chamber) or piezo-based ejection elements (for instance, a mechanical actuator to transmit a force to printing fluid) Subsequently, the printing fluid chamber is refilled via an inlet of the printing fluid chamber with printing fluid such that the previously expelled printing fluid is replenished. In some examples, the printing fluid chamber may further comprise an outlet to provide a fluid path from the inlet of the printing fluid chamber to the outlet of the printing fluid chamber.

In an example, a printing fluid chamber may comprise a plurality of printing fluid channels. For example, a printing fluid chamber may comprise a first printing fluid channel and a second printing fluid channel arranged to be in fluidic communication with the first printing fluid channel. In an example, the first printing fluid channel may comprise an inlet to receive printing fluid, an outlet to output printing fluid, and a printing fluid ejection element between the inlet and the outlet In some examples, the second printing fluid channel may comprise an actuator to improve the decap performance of the printing fluid ejection device. Examples of actuators comprise thermal-based actuators (for instance, a heat transducer to selectively heat printing fluid in a region associated with the actuator) or piezo-based actuators (for instance, a mechanical actuator that selectively pushes printing fluid).

In some examples, the actuator is arranged with respect to the printing fluid ejection element such that, in response to a trigger signal, the actuator is fired and printing fluid within the first printing fluid channel and the second printing fluid channel is disrupted. As previously explained, the firing of the actuator results in a pressure differential within the printing fluid chamber. In particular, the pressure differential is generated within the second printing fluid channel. Because of the fluidic communication between printing fluid channels, the pressure differential moves through the printing fluid channels until reaching a nozzle meniscus region associated with the nozzle. If the pressure differential that reaches the nozzle meniscus region is greater than a minimum pressure differential value, the printing fluid located at the nozzle meniscus region is refreshed. On the other hand, if the pressure differential is greater than a maximum pressure differential value, the pressure differential may result in a printing fluid ejection through the nozzle corresponding to the printing fluid ejection element. In some examples, the actuator is arranged with respect to the printing fluid ejection such that the firing of the actuator refreshes the printing fluid in the nozzle meniscus region while not ejecting printing fluid droplets through the nozzle (i.e., the pressure differential generated by the actuator over a period of time results in a zero-growth of the printing fluid within the printing fluid chamber). In this way, printing fluid waste associated with spitting operations is reduced while improving the decap performance. In some examples, the position of the actuator with respect to the printing fluid ejection element may be associated with a pressure differential value that will reach the printing fluid ejection element. In particular, in some examples, the minimum pressure differential value and the maximum pressure differential value may be associated with a range of admissible distances between the actuator and the printing fluid ejection member.

According to an example, the refreshing operation may be performed while the printing fluid ejection member of the printing fluid ejection assembly is idle (e.g, is not ejecting printing fluid out of the nozzle). In some other examples, the refreshing operation may be performed in parallel to other operations, such as micro-recirculation or macro-recirculation operations.

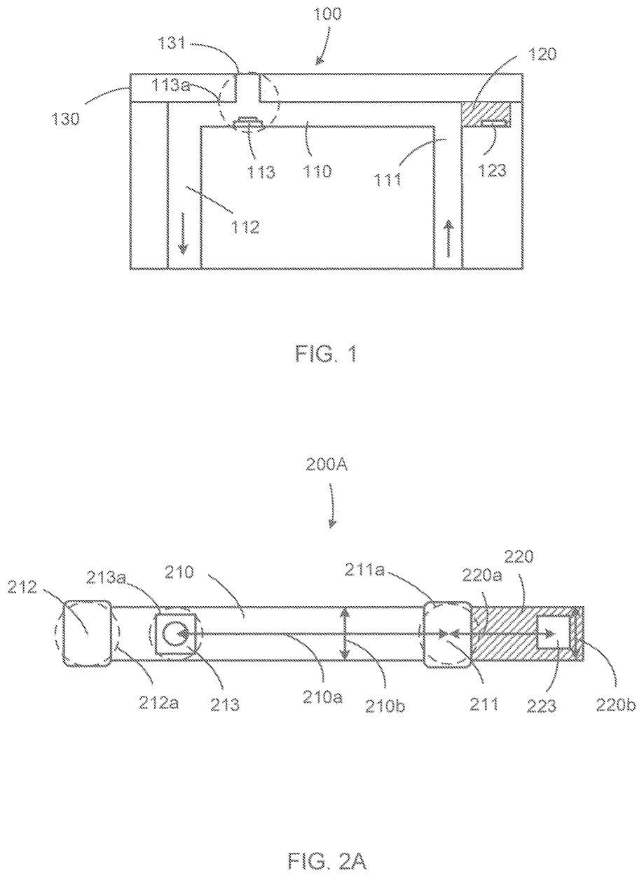

Referring now to FIG. 1, a cross-sectional side view of a printing fluid ejection assembly 100 is shown. The printing fluid ejection assembly 100 comprises a first printing fluid channel 110, a second printing fluid channel 120 (represented in hatched lines) arranged with respect to the first printing fluid channel 110, and a nozzle layer 130. The first printing fluid channel 110 comprises an inlet 111 to receive printing fluid, an outlet 112 to output printing fluid from the first printing fluid channel 110, and a printing fluid ejection element 113 between the inlet 111 and the outlet 112. The second printing fluid channel 120 comprises an actuator 123 in fluidic communication with the printing fluid ejection element 113 of the first printing fluid channel 110. As previously explained, each of the printing fluid ejection element 113 and the actuator 123 may be thermal-based or piezo-based. The nozzle layer 130 of the printing fluid ejection assembly 100 comprises a nozzle 131 arranged with respect to the printing fluid ejection element 113 of the first printing fluid channel 110.

In use, the printing fluid ejection element 113 causes printing fluid located at a meniscus region 113a to be ejected out of the nozzle 131 of the nozzle layer 130. Subsequently, the first printing fluid channel 110 is replenished with printing fluid received from the inlet 111. In an example, during a recirculation operation, the printing fluid may flow from the inlet 111 of the first printing fluid channel 110 to the outlet 112 of the first printing fluid channel 110. However, as the printing fluid moves from the inlet 111 to the outlet 112, printing fluid particles may settle around or in the meniscus region 113a. For instance, in FIG. 1, printing fluid particles may settle in the meniscus of the meniscus region 113a associated with the nozzle 131.

In FIG. 1, the second printing fluid channel 120 includes the actuator 123. The second printing fluid channel 120, may comprise a wide range of lengths and different types of cross-sectional areas and/or shapes. However, as previously explained, if the actuator 123 is positioned at a distance of the printing fluid ejection element 113 (and therefore at a distance from the meniscus region 113a), a firing of the actuator 123 refreshes the printing fluid located at the meniscus region 113a. In this way, in response to reception of refresh signals, the actuator 123 is to fire and refresh printing fluid in the meniscus region 113a. In some examples, the firing of the actuator 123 refreshes the meniscus associated with the nozzle 131 when the actuator 123 is positioned at a distance within a range of admissible distances with respect to the printing fluid ejection element 113.

In some examples, the actuator 123 may be arranged with respect to the printing fluid ejection element 113 based on a geometry of a fluid path defined from the actuator 123 to the printing fluid ejection element 113. In other examples, the actuator 123 may be in fluidic communication with the printing fluid ejection element 113 via a series of fluid paths, wherein the actuator 123 may be arranged with respect to the printing fluid ejection element 113 based on geometries of the series of fluid paths. In some other examples, to effectively refresh the meniscus region 113a associated with the nozzle 131, the actuator 123 may be positioned at a distance within a range of admissible distances with respect to the printing fluid ejection element 113. Therefore, if the actuator 123 is positioned within the range of admissible distances, the firing of the actuator 123 results in an effective printing fluid refreshing operation at the meniscus region. On the other hand, if the actuator 123 is positioned at a distance outside the range of admissible distances, the firing of the actuator 123 may result in a faulty refreshing operation. In an example, if the actuator 123 is located at a shorter distance than the lower limit of the admissible range, the firing of the actuator 123 may result in a printing fluid droplet being ejected out of the nozzle 131. On the other hand, if the actuator 123 is located at a distance greater than the upper limit of the admissible range, the firing of the actuator 123 may not effectively refresh the printing fluid at the meniscus region 113a.

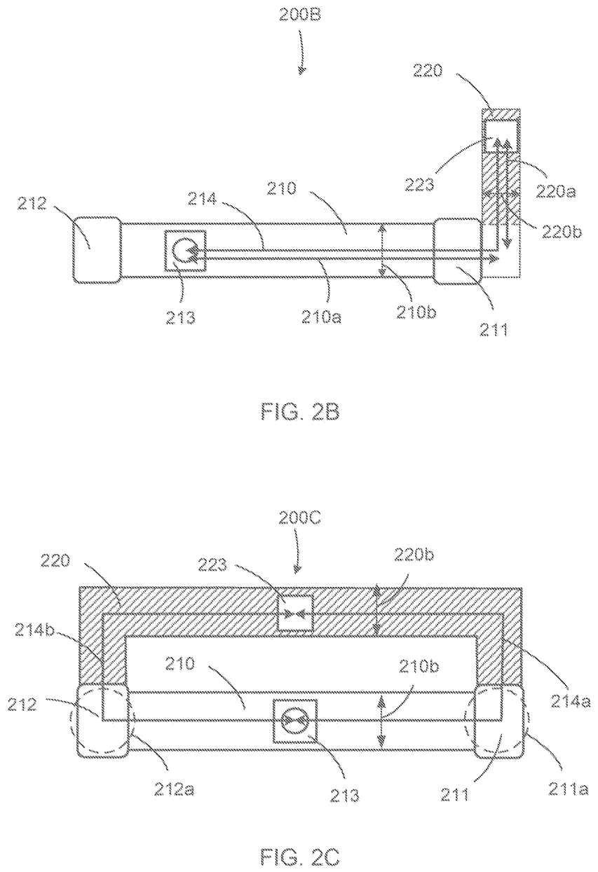

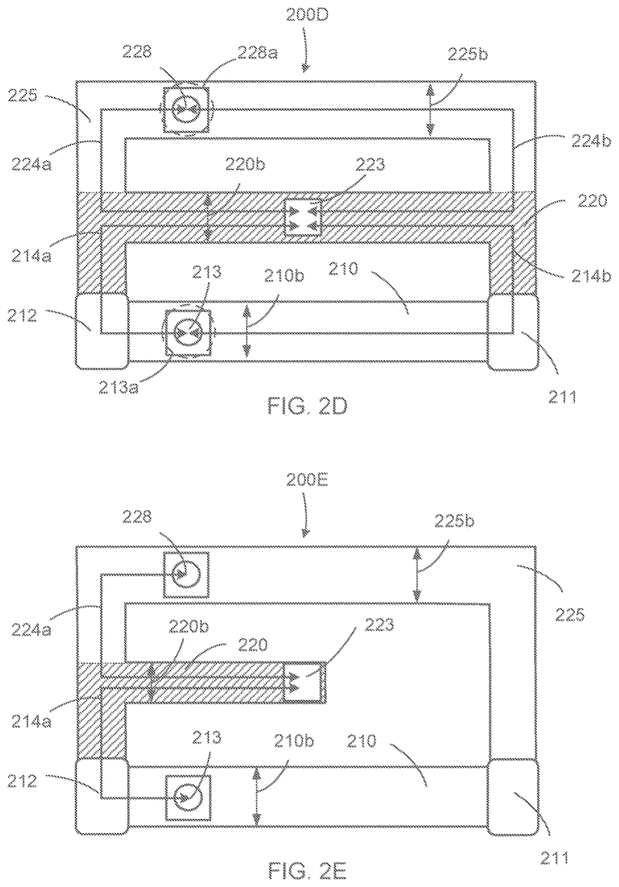

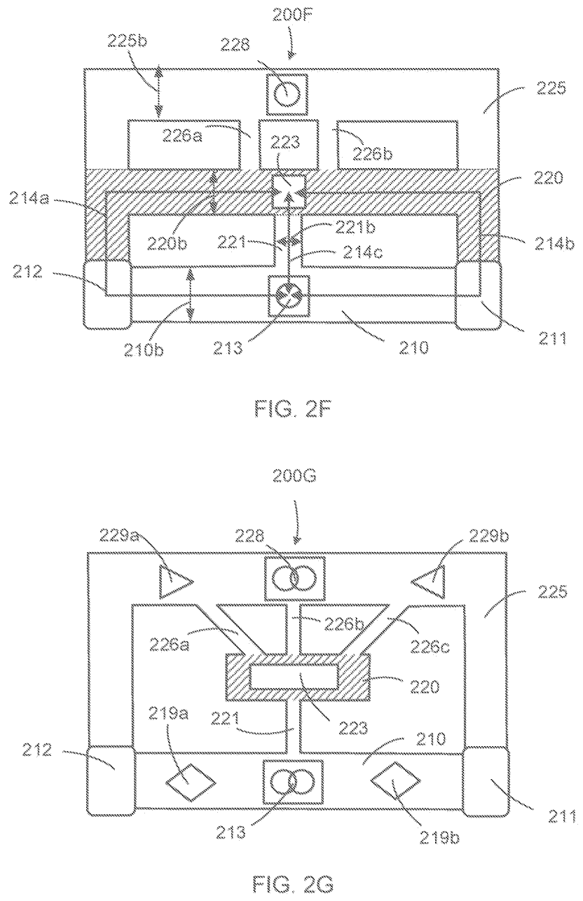

Referring now to FIG. 2A, a top view of a printing fluid ejection assembly 200A is shown. The printing fluid ejection assembly 200A comprises a first printing fluid channel 210 and a second printing fluid channel 220 (represented in hatched lines) arranged with respect to the first printing fluid channel 210. The first printing fluid channel 210 comprises an inlet 211 to receive printing fluid, an outlet 212 to output printing fluid, and a printing fluid ejection element 213 between the inlet 211 and the outlet 212. The second printing fluid channel 220 comprises an actuator 223 arranged with respect to the printing fluid ejection element 213.

In FIG. 2A, the actuator 223 is in fluidic communication with the first printing fluid ejection element 213 of the first printing fluid channel 210 via an inlet region 211a associated with the inlet 211 such that, in response to reception of refresh signals, the actuator 223 is to fire and refresh printing fluid in a nozzle meniscus region 213a. In particular, the inlet region 211a may correspond to a volume of the first printing fluid channel 210 resulting from a projection of the inlet 211 to the first printing fluid channel 210. In this way, a pressure differential generated by the actuator 223 in response to the refresh signals will be transmitted to the printing fluid entering the first printing fluid channel via the inlet 211. However, in other examples, the actuator 223 may be in fluidic communication with the first printing fluid channel 210 via an outlet region 212a associated with the outlet 212, wherein the outlet region 212a may correspond to a volume of the first printing fluid channel 210 resulting from a projection of the outlet 212 to the first printing fluid channel 210.

As previously explained, arranging the actuator 223 with respect to the printing fluid ejection element 213 at a distance within a range of admissible distances enables improves the decap performance while reducing the cost associated with servicing operations or external devices. In some examples, the range of admissible distances may be determined based on a geometry of the fluid path(s) from the actuator 223 to the printing fluid ejection element 213. Therefore, the range of admissible distances may be modified by varying the geometries of at least one of the first printing fluid channel 210 and the second printing fluid channel 220. For instance, in the printing fluid ejection assembly 200A represented in FIG. 2A, the fluid path from the actuator 223 to the printing fluid ejection element 213 comprises a first section along the first printing fluid channel 210 and a second section along the second printing fluid channel 220. The first section has a length 210a, a width 210b, and a first height (not represented in FIG. 2A). The second section has a length 220a, a width 220b, and a second height (not represented in FIG. 2A). In an example, a distance from the actuator 223 to the printing fluid ejection element 213 (i.e., the sum of the length 210a plus the length 220a) has to be within the range of admissible distance in order to obtain an effective refreshing operation when firing the actuator 223

Referring now to FIG. 2B, a top view of a printing fluid ejection assembly 200B comprising a first printing fluid channel 210 in fluidic communication with a second printing fluid channel 220 is shown. The first printing fluid channel 210 has a first width 210b and the second printing fluid channel 220 has a second width 220b, the first width 210b being greater than the second width 220b. As previously explained, the distances at which the actuator effectively refreshes the nozzle meniscus region depend on the geometry of the fluid path from the actuator 223 to the printing fluid ejection element 213. For example, in FIG. 2B, the fluid path from the actuator 223 to the printing fluid ejection element 213 comprises a first section and a second section, wherein the first section is defined from the center of the actuator 223 to the center of the elbowed connection and the second section is defined from the center of the elbowed connection to the center of the printing fluid ejection element 213. Hence, as previously described, if any of the dimensions defining the geometry of the first section or the second section is modified, the range of admissible distances is modified accordingly.

In some examples, the range of admissible distances may be adjusted by modifying the geometry of at least one section forming the fluid path from the actuator 223 to the printing fluid ejection element 213. In this way, more compact printing fluid ejection assemblies may be obtained. In an example, the width of a section of the fluid path may be modified. In other examples, the height of a section of a fluid path may be modified.

Although in FIG. 2B the second printing fluid channel 220 is oriented substantially perpendicular with respect to the first printing fluid channel 210, in other examples the second printing fluid channel 220 may be aligned with respect to the first printing fluid channel 210. However, it should be noted that when having a second printing fluid channel 220 perpendicular to a first printing fluid channel 210, the overall length, from left to right (on the page in the case of the drawings), of the printing fluid ejection assembly 200B is reduced compared to printing fluid assemblies in which the first printing fluid channel 210 and the second printing fluid channel 220 are aligned (e.g., the printing fluid ejection assembly 200A).

According to an example, each of the printing fluid ejection assemblies 200A and 2008 may comprise a first section and a second section having geometries within a range of geometries. For instance, the first section along the first printing fluid channel 210 may have a length (e.g., 210a) within a range from 60 to 100 μm, a width (e.g., 210b) within a range from 30 to 40 μm, and a height within a range from 12 to 21 μm. On the other hand, the second section along the second printing fluid channel 220 may have a length (e.g., 220a) within a range from 20 to 30 μm, a width (e.g., 220b) within a range from 15 to 30 μm, and a height within a range from 15 to 25 μm. As a result, a range of admissible distances in which the firing of the actuator 223 effectively refreshes the meniscus region is a range from 80 to 130 μm (i.e., the sum of the length of the first portion plus the length of the second portion). In some examples, at least one dimension (e.g., the width or the height) of the second section may be modified such that a range of admissible distances is reduced (i.e., the length along the second section decreases).

Referring now to FIG. 20, a top view of a printing fluid ejection assembly 200C comprising a first printing fluid channel 210 in fluidic communication with a second printing fluid channel 220 via an inlet region 211a and an outlet region 212a is shown. As previously explained, the inlet region 211a is associated with the inlet 211 of the first printing fluid channel 210 and the outlet region 212a is associated with the outlet 212 of the first printing fluid channel 210. Thus, instead of having a single fluid path from the actuator 223 to the printing fluid ejection element 213, multiple fluid paths are defined.

In FIG. 2C, the actuator 223 is at an intermediate position with respect to the inlet 211 and the outlet 212 of the first printing fluid channel 210. In this way, the pressure differential created by the actuator 223 along the channels does not result in a net flow through the first printing fluid channel 210. Similarly, the printing fluid ejection element 213 is at an intermediate position with respect to the inlet 211 and the outlet 212. Since the second printing fluid channel 220 is in fluidic communication with the first printing fluid channel 210 via the inlet region 211a and the outlet region 212a, a first fluid path 214a and a second fluid path 214b from the actuator 223 to the printing fluid ejection member 213 are established. In addition, each of the fluid paths includes a first section along the first printing fluid channel 210 and a second section along the second printing fluid channel 220. Along the first section, the fluid paths 214a and 214b have a first width 210b corresponding to the width of the first printing fluid channel 210. Along the second section, the fluid paths 214a and 214b have a second width 220b corresponding to the width of the second printing fluid channel 220. Due to the symmetry of the embodiment, in FIG. 20, the length of the first fluid path 214a is equal to the length of the second fluid path 214b.

As previously explained, the range of admissible distances in which the actuator 223 effectively refreshes the printing fluid is based on the geometries of the fluid paths from the actuator 223 to the printing fluid ejection element 213. When having more than a fluid path available from the actuator 223 to the printing fluid ejection element 213, arranging the actuator 223 at a different location will impact each of the first fluid path 214a and the second fluid path 214b. For instance, in FIG. 20, positioning the actuator 223 closer to the inlet 211 will result in a decrease in the length of the first fluid path 214a and an increase in the length of the second fluid path 214b. To effectively improve the decap performance while not ejecting printing fluid through the nozzles, each of the length of the first fluid path 214a and the length of the second fluid path 214b have to be within the range of admissible distances.

In some examples, the addition of fluid paths from an actuator to a printing fluid ejection further reduces the range of admissible distances thereby providing more compact printing fluid ejection assemblies. Similarly, the use of different geometries may reduce the overall size of the printing fluid ejection assembly. However, in some examples, the dimensions of the first printing fluid channel including a printing fluid ejection element may have to meet other criteria associated with at least one of an effective fluid dispensing operation, an effective refilling operation of the printing fluid channel, or an effective recirculation operation.

Therefore, when considering modifications in a fluid path section along the first printing fluid channel, additional fluid paths from the second printing fluid channel to the first printing fluid channel may allow to obtain more compact printing fluid ejection assemblies without adversely affecting to other operations.

Referring now to FIG. 2D, a top view of a printing fluid ejection assembly 200D comprising a first printing fluid ejection element 213 and a second printing fluid ejection element 228 is shown. The printing fluid ejection assembly 200D comprises a first printing fluid channel 210 having a first width 210b, a second printing fluid channel 220 having a second width 220b, and a third printing fluid channel 225 having a third width 225b. The first printing fluid channel 210 comprises an inlet 211 to receive printing fluid, an outlet 212 to output printing fluid, and the first printing fluid ejection element 213. The second printing fluid channel 220 comprises an actuator 223 in fluidic communication with the first printing fluid ejection element 213 of the first printing fluid channel 210 via the inlet region and the outlet region. The third printing fluid channel 225 comprises the second printing fluid ejection element 228 in fluidic communication with the actuator 223.

In particular, in FIG. 2D, both ends the second printing fluid channel 220 are in fluidic communication with the first printing fluid channel 210 and the third printing fluid channel 225. Thus, multiple fluid paths are possible from the actuator 223 to each of the first printing fluid ejection element 213 and the second printing fluid ejection element 228. For instance, in regard to the first printing fluid ejection element 213, a first fluid path 214a and a second fluid path 214b from the actuator 223 to the first printing fluid ejection element 213 are established. On the other hand, in regard to the second printing fluid ejection element 228, a third fluid path 224a and a fourth fluid path 224b are established from the actuator 223 to the second printing fluid ejection element 228.

As previously explained, to effectively refresh a nozzle meniscus region (e.g., meniscus regions 213a and 228a), an actuator is arranged with respect to the printing fluid ejection elements 213 and 228 based on the geometry of the fluid path(s) from the actuator to the printing fluid ejection element(s). In FIG. 2D, each of the first fluid path 214a, the second fluid path 214b, the third fluid path 224a, and the fourth fluid path 224b comprise multiple sections. For instance, the first fluid path 214a and the second fluid path 214b of FIG. 2D comprise a first section along the first printing fluid channel 210 and a second section along the second printing fluid channel 220. However, for each of the fluid paths 214a and 214b, different lengths are defined for each of the sections. In particular, whereas the first section of the first fluid path 214a has a first length defined from the first printing fluid ejection element 213 to the center of the outlet 212, the first section of the second fluid path 214b has a second length defined from the first printing fluid ejection element 213 to the center of the inlet 211. Similarly, whereas the second section of the first fluid path 214a has a third length defined from the center of the outlet 212 to the actuator 223, the second section of the second fluid path 214b has a fourth length defined from the center of the inlet 211 to the actuator 223. As previously explained, each of the first printing fluid channels 210, 220 and 225 has a respective width 210b, 220b and 225b. Hence, the geometry of each section defining a fluid path is defined by the respective length of the section, the respective width of the section, and the respective height (not represented in FIG. 2D) of the section.

Referring now to FIG. 2E, a top view of a printing fluid ejection assembly 200E is shown. The printing fluid ejection assembly 200E comprises a first printing fluid channel 210 having a width 210b and including a first printing fluid ejection element 213, a second printing fluid channel 220 having a width 220b and including an actuator 223, and a third printing fluid channel 225 having a width 225b and including a second printing fluid ejection element 228. As previously explained, the actuator 223 is arranged with respect to the first printing fluid ejection element 213 and the second printing fluid ejection element 228 based on the geometry of the fluid path(s) from the actuator 223 to the printing fluid ejection elements 213 and 228 In particular, the printing fluid ejection assembly 200E corresponds to the printing fluid ejection assembly 200D with the second printing fluid channel 220 in fluidic communication with the first printing fluid channel 210 and the third printing fluid channel 225 via one of the ends of the second printing fluid channel 220.

In FIG. 2E, a first end is a closed-end and of the second printing fluid channel 220 is in fluidic communication with the first printing fluid channel 210 and the third printing fluid channel 225 via a second end. Thus, the actuator 223 is in fluidic communication with the first printing fluid ejection element 213 via a first fluid path 214a and in fluidic communication with the second printing fluid ejection element 228 via a second fluid path 224a. The first fluid path 214a includes a first section along the first printing fluid channel 210 and a second section along the second printing fluid channel 220. On the other hand, the second fluid path 224a includes a first section along the third printing fluid channel 225 and a second section along the second printing fluid channel 220.

Compared to the printing fluid ejection assembly 200D previously explained in FIG. 2D, the printing fluid ejection assembly 220E lacks the third fluid path from the actuator 223 to the first fluid ejection element 213 and the fourth fluid path from the actuator 223 to the second printing fluid ejection element 228. Thus, to compensate the lack of fluid paths to keep effectively refreshing the meniscus regions using the actuator 223, at least one of dimension defining the geometry of the first printing fluid channel 210, the second printing fluid channel 220, and the third printing fluid channel 225 may have to be modified. For instance, in the printing fluid ejection assembly 200E represented in FIG. 2E, the width 220b of the second printing fluid channel 220 has been reduced so that a cross-sectional area of the second printing fluid channel 220 is reduced. However, in other examples, other dimensions such as the height of one the channels may be modified. In some other examples, the length(s) may be increased. However, when increasing the length of a section defining the fluid path over the overall available length of a printing fluid channel, the overall size of the printing fluid ejection assembly may increase. In some other examples, additional fluid paths from the actuator 223 to each of the printing fluid ejection elements 213 and 228 may be established to reduce the overall size of the printing fluid ejection assembly.

Referring now to FIG. 2F, a top view of a printing fluid ejection assembly 200F comprising printing fluid channels fluidly connected via parallel channels is shown. The printing fluid ejection assembly 200F comprises a first printing fluid channel 210 having a width 210b, a second printing fluid channel 220 having a width 220b, and a third printing fluid channel 225 having a width 225b.

In FIG. 2F, the first printing fluid channel 210 comprises an inlet 211, an outlet 212, and a first printing fluid ejection element 213. The second printing fluid channel 220 comprises an actuator 223 in fluidic communication with the first printing fluid ejection element 213 via an inlet region, an outlet region, and a first parallel channel 221 having a width 221b. The third printing fluid channel 225 comprises a second printing fluid ejection element 228 in fluidic communication with the actuator 223 of the second printing fluid channel 220. In particular, the fluidic communication is obtained via a second parallel channel 226a, a third parallel channel 226b and connections between the third printing fluid channel 225 and the second printing fluid channel 220 at both ends of the third printing fluid channel 225.

As previously explained, the addition of fluid paths from the actuator 223 to the printing fluid ejection elements 213, 228 results in a modification of a range of admissible distances in which the actuator 223 effectively refreshes the printing fluid at the nozzle meniscus regions. Put another way, the addition of fluid paths enables to obtain more compact printing fluid ejection assemblies that effectively refresh the printing fluid at each of the nozzle meniscus regions. For instance, in the printing fluid ejection assembly 200F of FIG. 2F, the actuator 223 is in fluidic communication with the first printing fluid ejection element 213 via a first fluid path 214a, a second fluid path 214b, and a third fluid path 214c. In particular, the first fluid path 214a is established via the outlet region, the second fluid path 214b is established via the inlet region, and the third fluid path 214c is established via the first parallel channel 221. Also, as explained above, a fluid path is defined along multiple sections. For instance, in FIG. 2F, the first and second fluid paths 214a and 214b include a first section along the first printing fluid channel 210 and a second section along the second printing fluid channel 220. On the other hand, the third fluid path 214c includes a section along the first parallel channel 221.

Although in the printing fluid ejection assembly 200F the fluid paths from the actuator 223 to the second printing fluid ejection element 228 have not been represented, it should be understood that a fourth, fifth, sixth and seventh fluid paths are established from the actuator 223 to the second printing fluid ejection element 228. However, to simplify the representation in FIG. 2F, the fluid paths (and their respective widths) associated with the second printing fluid ejection element 228 have been omitted. Nonetheless, when considering the location of the actuator 223 with respect to the first printing fluid ejection element 223 and the second printing fluid ejection element 228, all the fluid paths (i.e., from the first to the seventh) and the respective geometries of their sections are considered.

Referring now to FIG. 2G, a top view of a printing fluid ejection assembly 200G is shown. The printing fluid ejection assembly 200G comprises a first printing fluid channel 210 including a first printing fluid ejection element 213, a second printing fluid channel 220 including an actuator 223, and a third printing fluid channel 225 including a second printing fluid ejection member 228. The first printing fluid ejection element 213 and the second printing ejection member 228 correspond to dual-drop weight printing fluid ejection members. However, in other examples, other types of printing fluid ejection members may be used.

The first printing fluid channel 210 of the printing fluid ejection assembly 200G comprises an inlet 211, an outlet 212, the first printing fluid ejection element 213, and diamond-shaped tolerance pillars 219a, 219b. The third printing fluid channel 225 comprises the second printing fluid ejection element 228 and triangle-shaped tolerance pillars 229a, 229b. Among others, the tolerance pillars 219a, 219b, 229a, and 229b help to promote movement of the printing fluid flowing through their respective printing fluid channels. In addition to the first printing fluid channel 210 and the third printing fluid channel 225, the printing fluid ejection assembly 200G further comprises the second printing fluid channel 220 in fluidic communication with the first printing fluid channel 210 and the third printing fluid channel 225.

In FIG. 2G, the first printing fluid channel 210 is fluidly connected to the third printing fluid channel 225 via an inlet region and an outlet region of the first printing fluid channel 210. The second printing fluid channel 220, contrary to the printing fluid ejection assemblies explained in reference to FIGS. 2C, D and F, is not fluidly connected to the first printing fluid channel 210 via the inlet region and the outlet region. Instead, the second printing fluid channel 220 is in fluidic communication with the first printing fluid channel 210 via a series of parallel channels comprising a first parallel channel 221, a second parallel channels 226a, a third parallel channel 226b, and fourth parallel channel 226c. In this way, the pressure differentials generated by the actuator 223 effectively reach each of the first printing fluid ejection member 213 and the second printing fluid ejection member 228.

Although in FIG. 2G the fluid paths from the actuator 223 to the first printing fluid ejection element 213 and the second printing fluid ejection element 228 have been omitted, it should be noted that the actuator 223 is arranged with respect to the printing fluid ejection elements 213 and 228 based on the respective fluid paths and their geometries. For instance, in FIG. 2G, the actuator 223 is in fluidic communication with the first printing fluid ejection element 213 via the first parallel channel 221, the second parallel channel 226a, and the fourth parallel channel 226c. On the other hand, the actuator 223 is in fluidic communication with the second printing fluid ejection element 228 via the second parallel channel 226a, the third parallel channel 226b, and the fourth parallel channel 226c.

According to an example, a range of admissible distances from an actuator to a printing fluid ejection member of a printing fluid ejection assembly may be determined based on a printing fluid ejection assembly lumped parameter (PFEALP) In an example, the PFEALP may be determined based on a lumped parameter equation, being the lumped parameter equation a function of length(s) of the fluid path(s) from the actuator to the printing fluid ejection member, height(s) of the fluid path(s) from the actuator to the printing fluid ejection members, width(s) of the fluid path(s) from the actuator to the printing fluid ejection members, and a number of singular fluid paths (i.e., non-overlapping fluid paths) from the actuator to the printing fluid ejection members. In an example, a PFEALP may be defined by the following equation:

$$P F E A L {P}_{j} = {[ {\sum }_{i = N} \frac{i}{{\sum }_{i = n} \frac{{L}_{i}}{{( {W}_{i} {H}_{i} )}^{2}}} ]}^{- 1} ;$$

Where “PFEALPj” corresponds to the printing fluid ejection assembly lumped parameter for a printing fluid ejection element “j”, “Lᵢ” corresponds to the distance from the actuator to a printing fluid ejection element “j” in a section “n” of a fluid path “i”, “N” corresponds to the number of fluid paths “i” that fluidly connect the actuator with the printing fluid ejection element “j”, “n” the number of sections defining a fluid path “i”, “Wᵢ” corresponds to the width of a section “n” of a fluid path “i”, and “Hᵢ” corresponds to the height of a section “n” of a fluid path “i”. In an example, an actuator may effectively refresh the nozzle meniscus regions when the PFEALP is within a range defined from 0.0001 μm⁻³ to 0.003 μm⁻³.

As previously explained, in some examples, the pressure differential generated by an actuator may depend on the size of the actuator. In particular, when using thermal-based actuators, the firing of the actuator will cause printing fluid nearby a surface of the actuator to vaporize, and therefore, the pressure differential generated by the actuator is a function of an actuator area. In an example, an actuator may effectively perform a refreshing operation if an actuator ratio (AR) between an area of the actuator and the PFEALP is within a range of admissible values. In particular, the actuator ratio (AR) may be defined as:

$$A {R}_{j} = \frac{{A}_{actuator}}{P F E A L {P}_{j}} ;$$

Where “ARj” corresponds to the actuator ratio for a printing fluid ejection element “j”. “A_{actuator}” corresponds to an area of the actuator and “PFEALPj” corresponds to the printing fluid ejection assembly lumped parameter determined based on the geometry of the printing fluid ejection assembly. In an example, the pressure differential generated by the actuator will effectively refresh printing fluid at the meniscus region if the actuator ratio (AR) is within a range. In an example, a bottom limit value of the range may be associated with the minimum actuator ratio value in which the refreshing operation effectively refreshes the printing fluid at the meniscus region and an upper limit value of the range may be associated with the maximum actuator ratio value in which the refreshing operation effectively refreshes the printing fluid at the meniscus region without a risk of unintended printing fluid drop ejection through the nozzle in fluidic communication with the meniscus region. In an example, the range may be from 10 000 μm⁵ to 800 000 μm⁵. In other examples, the actuator ratio (AR) may be within a range from 20 000 μm⁵ to 700 000 μm⁵. In some other examples, the range may be from 20 000 μm⁵ to 500 000 μm⁵. In further examples, the range may be from 20 000 μm⁵ to 800 000 μm⁵. However, when using other types of actuator such as piezo-based actuators, the ranges defined for actuator ratio (AR) may be different.

Although in the printing fluid ejection assemblies 200A to 200G described in reference to FIGS. 2A to 2G the nozzle layers of each printing fluid ejection assembly have not been represented for illustrative purposes, it should be understood that each of the assemblies comprises a nozzle layer including a nozzle (or nozzles, when having multiple printing fluid ejection members) arranged to correspond to the printing fluid ejection member (or members).

Also, it should be understood that printing fluid ejection assemblies 200A to 200G described in reference to FIGS. 2A to 2G may be subjected to modifications. For instance, the actuator may be located at an intermediate position with respect to the inlet and the outlet of the first printing fluid channel 210 such that the firing of the actuator does not create a net flow which may have an impact on other operations such as recirculation operations (e.g., micro-recirculation and macro-recirculation). On the other hand, in other examples, the actuator may be located asymmetrically with respect to the inlet and the outlet to create a net flow that flows printing fluid through the first printing fluid channel 210. Also, in some other examples, an inlet of the printing fluid channel may act as an outlet and an outlet of the printing fluid channel may act as an inlet. Hence, referring to FIGS. 2A to 2G, the printing fluid may flow through the first printing fluid channel 210 from the outlet 212 to the inlet 211. In some other examples, the printing fluid may alternatively flow through the first printing fluid channel 210 from the inlet 211 to the outlet 212 and from the outlet 212 to the inlet 211.

According to an example, the PFEALP and the AR of the printing fluid ejection assemblies 200A to 200E may be obtained based on the geometries of the printing fluid channels and the area of the actuator 223. In an example, the parameters associated with the first printing fluid ejection element 213 may be determined as follows:

TABLE 1

| | | Li, | Wi, | Hi, | Li, | Wi, | Hi, | | | |
|---|---|---|---|---|---|---|---|---|---|---|
| | | n = 1 | n = 1 | n = 1 | n = 2 | n = 2 | n = 2 | Aact | PFEALP | AR |
| FIG. | i | (μm) | (μm) | (μm) | (μm) | (μm) | (μm) | (μm²) | (μm⁻³) | (μm⁵) |
| 2A | 1 | 62 | 34 | 21 | 24 | 18 | 21 | 224 | 2.90E−4 | 7.74E+5 |
| 2B | 1 | 92 | 34 | 14 | 24 | 18 | 14 | 224 | 7.84E−4 | 2.86E+5 |
| 2C | 1 | 46 | 25 | 14 | 23 | 20 | 14 | 240 | 3.26E−4 | 7.36E+5 |
| | 2 | 46 | 25 | 14 | 23 | 20 | 14 | | | |
| 2D | 1 | 45 | 16 | 21 | 23 | 25 | 21 | 240 | 3.19E−4 | 7.52E+5 |
| | 2 | 85 | 16 | 21 | 53 | 25 | 21 | | | |
| 2E | 1 | 26 | 18 | 14 | 10 | 8 | 21 | 224 | 7.64E−4 | 2.93E+5 |

Where the first column contains a reference to the figures representing the assemblies 200A to 200E, “i” corresponds to the number of fluid paths from the actuator 223 to the first printing fluid ejection element 213, “Li, n=1” corresponds to the length of the fluid path “i” along a long axis of the first printing fluid channel 210, “Wi, n=1” corresponds to the width of the fluid path “i” in a first short axis of the first printing fluid channel 210 (i.e., the width 210b), “Hi, n=1” corresponds to the height of the fluid path “i” in a second short axis of the first printing fluid channel 210, “Li, n=2” corresponds to the length of the fluid path “i” along a long axis of the second printing fluid channel 220, “Wi, n=2” corresponds to the width of the fluid path “I” in a first short axis of the second printing fluid channel 220 (i.e., the width 220b), “Hi, n=2” corresponds to the height of the fluid path “I” in a second short axis of the second printing fluid channel 220, and “Aact” corresponds to the area of the actuator 223. Based on these values, the “PFEALP” and the “AR” corresponding to the first printing fluid ejection element 213 are calculated using the equations previously described. In some examples, the range of admissible distances associated with an effective refreshing operation may be based on the PFEALP, wherein the sum of each length of the portions defining a fluid path from the actuator 223 to the printing fluid ejection element 213 corresponds to the distance at which the actuator 223 is to be arranged with respect to the printing fluid ejection element 213.

With respect to the printing fluid ejection assemblies 200F and 200G, the parameters associated with the first printing fluid ejection element 213 may be determined as follows when each of the printing fluid channels has a common width “VI” and a common height “Hi” along the fluid path “i”:

TABLE 2

| | | Li, | Li, | Li, | | | | | |
|---|---|---|---|---|---|---|---|---|---|
| | | n = 1 | n = 2 | n = 3 | Wi, | Hi, | Aact | PFEALP | AR |
| FIG. | i | (μm) | (μm) | (μm) | (μm) | (μm) | (μm²) | (μm⁻³) | (μm⁵) |
| 2F | 1 | 25 | 35 | — | 5 | 14 | 224 | 2.42E−3 | 9.26E+5 |
| | 2 | 25 | 35 | — | 5 | 14 | | | |
| | 3 | — | — | 10 | 5 | 10 | | | |
| 2G | 1 | 35 | 55 | — | 5 | 21 | 240 | 4.54E−4 | 5.29E+5 |
| | 2 | 35 | 55 | — | 5 | 21 | | | |
| | 3 | — | — | 10 | 10 | 14 | | | |

Where the first column contains a reference to the figures representing the assemblies 200F and 200G, “i” corresponds to the number of fluid paths from the actuator 223 to the first printing fluid ejection element 213, “Li, n=1” corresponds to the length of the fluid path “i” along a long axis of the first printing fluid channel 210. “Li, n=2” corresponds to the length of the fluid path “I” along a long axis of the second printing fluid channel 220, “Li, n=3” corresponds to the length of the fluid path “i” along a long axis of the first parallel channel 221, “Wi” corresponds to the width of the fluid path “i”, “Hi” corresponds to the height of the fluid path “i”, and “Aact” corresponds to the area of the actuator 223. Based on these values, the “PFEALP” and the “AR” corresponding to the first printing fluid ejection element 213 are calculated using the equations previously described.

Although Tables 1 and 2 define some dimension values of the fluid paths of the printing fluid ejection assemblies 200A to 200G, it should be understood that other dimension values may be possible. Also, it should be noted that, when having a second printing fluid ejection element 228 (for instance, the assemblies 200D to 200E of FIGS. 20 to 2E), a second PFEALP and a second AR may be obtained based on the geometries of the fluid paths from the actuator 223 to the second printing fluid ejection element 228. However, in order to simplify the explanation in reference to Tables 1 and 2, the second PFEALP and the second AR associated with the second printing fluid ejection element 228. Likewise, to simply the contents of Table 2, a common width and a common height along the sections of the fluid paths has been used. However, in other examples, each of the first printing fluid channel 210, the second printing fluid channel 220, and the first parallel channel 221 may comprise respective widths and heights.

In some examples, the actuator 223 will effectively refresh the meniscus region associated with the printing fluid ejection element 213 if the actuator 223 is positioned within a range of admissible distances associated with a PFEALP within a range from 0.0001 μm⁻³ to 0.003 μm⁻³. In some other examples, the actuator 223 may effectively perform the refreshing operation if the AR is within a range from 20 000 μm⁵ to 800 000 μm⁵.

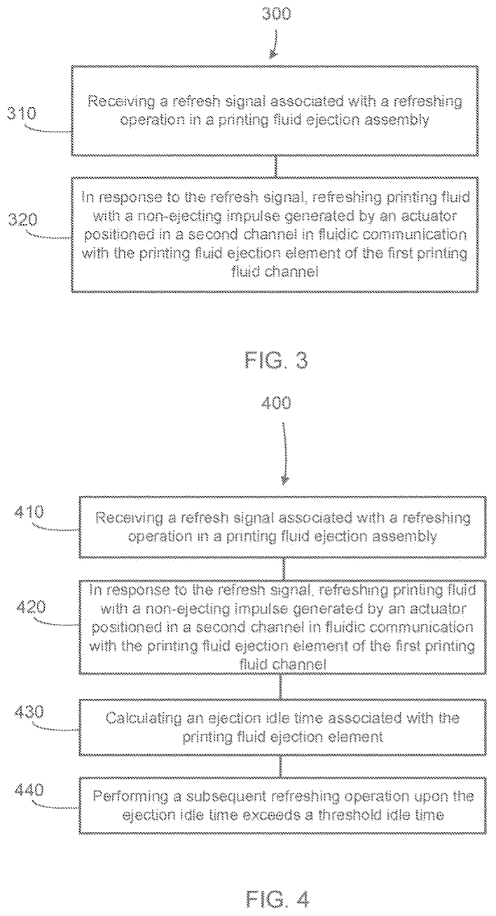

Referring now to FIG. 3, a method 300 for refreshing printing fluid is shown. As previously explained in reference to other examples, actuators may be used to refresh the printing fluid at a meniscus region associated with a nozzle. At block 310, method 300 comprises receiving a refresh signal associated with a refreshing operation in a printing fluid ejection assembly. The printing fluid ejection assembly, which may correspond to any of the printing fluid ejection assemblies 100, 200A-200G previously described in FIGS. 1 to 2G, comprises a first printing fluid channel (e.g., first printing fluid channel 110 in FIG. 1, first printing fluid channel 210 in FIGS. 2A-2G) including a printing fluid inlet (e.g., inlet 111 in FIG. 1, inlet 211 in FIGS. 2A. 2G), a printing fluid outlet (e.g., outlet 112 in FIG. 1, outlet 212 in FIGS. 2A-2G), and a printing fluid ejection element (e.g., printing fluid ejection element 113 in FIG. 1. printing fluid ejection element 213 in FIGS. 2A-2G) arranged to correspond to a nozzle (or nozzles, when having multiple printing fluid ejection elements). Then, at block 320, method 300 comprises in response to the refresh signal, refreshing printing fluid with a non-ejecting impulse generated by an actuator (e.g., actuator 123 in FIG. 1, actuator 223 in FIG. 2A-2G) positioned in a second printing fluid channel (e.g., second printing fluid channel 120 in FIG. 1, second printing fluid channel 220 in FIGS. 2A-2G) in fluidic communication with the first printing fluid ejection element of the first printing fluid channel. As a result of the non-ejecting impulse, the printing fluid at a meniscus region associated with the nozzle is refreshed.

In some examples, refresh signals may be received during a start-up routine or a power-off routine of a printing system including the printing fluid ejection assembly. In other examples, the refresh signals may be received during the printing operation. In particular, when refresh signals are received during the printing operation, such refresh signals may be received upfront a subsequent ejecting operation of the nozzle. In this way, the printing fluid is refreshed before the subsequent printing operation. In some examples, the refresh signals may be based on the print job content, wherein for each nozzle(s) of the printing fluid ejection assembly, a refresh signal triggers a refreshing operation for the nozzle(s) based on a non-ejecting impulse generated by an actuator.

In some other examples, the printing fluid ejection assembly may further comprise a third printing fluid channel (e.g., third printing fluid channel 225 in FIGS. 2D-2G) comprising a second printing fluid ejection element (e.g., second printing fluid ejection element 228 in FIGS. 2D-2G) arranged to correspond to a second nozzle, wherein the second printing fluid ejection element is in fluidic communication with the actuator of the second printing fluid channel such that the non-ejecting impulse generated by the actuator refreshes printing fluid at a second meniscus region associated with the second nozzle.

According to some examples, refresh signals may be based on a print job to be printed by a printing system comprising a plurality of printing fluid assemblies. As explained above, the refresh signals may be received in response to powering on the printing system, in response to powering off the printing system, or before a printing fluid ejection to be performed by the printing fluid ejection assembly. However, based on the content of the print job to be printed by the printing system, some nozzles of the printing fluid assemblies may exceed a threshold idle time associated with a subsequent faulty printing fluid ejection operation. Therefore, additional refreshing operations may have to be performed to obtain a proper performance without ejecting printing fluid to refresh the meniscus region(s).

Referring now to FIG. 4, a method 400 for refreshing printing fluid is shown. Method 400 may be performed for improving a decap performance of a printing fluid ejection assembly while not ejecting printing fluid. At block 410, method 400 comprises receiving a refresh signal associated with a refreshing operation in a printing fluid ejection assembly (e.g., printing fluid ejection assembly 100 in FIG. 1, printing fluid ejection assemblies 200A-200G in FIGS. 2A-2G). At block 420, method 400 comprises refreshing printing fluid with a non-ejecting impulse generated by an actuator (e.g., actuator 123 in FIG. 1, actuator 223 in FIG. 2A-2G) positioned in a second printing fluid channel (e.g., second printing fluid channel 120 in FIG. 1, second printing fluid channel 220 in FIGS. 2A-2G) in fluidic communication with a printing fluid ejection element (e.g., printing fluid ejection element 113 in FIG. 1, printing fluid ejection element 213 in FIGS. 2A-2G) of a first printing fluid channel (e.g., first printing fluid channel 110 in FIG. 1, first printing fluid channel 210 in FIGS. 2A-2G) As previously explained, in some examples, the actuator may be arranged at a distance with respect to the printing fluid ejection element. In particular, the distance may be within a range of admissible distances in which the printing fluid at a meniscus region of the nozzle is effectively refreshed while not ejecting printing fluid out of the nozzle. At block 430, method 400 comprises calculating an ejection idle time associated with the printing fluid ejection element. In an example, the ejection idle time may be determined from the last printing fluid ejection performed by the printing fluid ejection element. In other examples, the ejection idle time may be determined from the last refreshing operation at the meniscus region. In some other examples, the ejection idle time may be the longer time from the last printing fluid ejection or the last refreshing operation. Then, at block 440, method 400 comprises performing a subsequent refreshing operation upon the ejection idle time exceeds a threshold idle time. In some examples, to perform the subsequent refreshing operation, the actuator may generate a subsequent non-ejecting impulse.

As previously explained, excessive ejection idle times associated with printing fluid ejection element(s) may result in faulty subsequent printing fluid ejection(s). Hence, by performing refreshing operations based on refresh signals and the ejection idle times, the printing fluid at the meniscus region(s) is effectively refreshed thereby improving the decap performance of the printing fluid ejection assembly.

In some examples, methods 300 and 400 may be performed to effectively refresh the printing fluid at the meniscus regions of an array of printing fluid assemblies.

According to an example, a printing system may comprise a controller and a plurality of printing fluid ejection assemblies, wherein each of the printing fluid ejection assemblies may correspond to any of the assemblies previously explained in FIGS. 1 to 2G. The plurality of printing fluid ejection assemblies comprises a plurality of nozzles to dispense printing fluid on a media. As previously explained, to dispense printing fluid out of the nozzles, printing fluid ejection elements are arranged to correspond with the nozzles. To effectively refresh the printing fluid at the meniscus regions, the controller may selectively control an actuator of each of the printing fluid ejection assembly. In particular, the controller may control the actuator to fire such that a pressure differential is generated within the printing fluid channels of the respective printing fluid ejection assembly. If the actuator is arranged with respect to the printing fluid ejection element within a range of admissible distances, the firing of the actuator will result in a refreshing operation that refreshes the printing fluid in the meniscus region. In some other examples, as previously explained in reference to FIGS. 3 and 4, refreshing operations may be performed in response to refresh signals and in response to ejection idle times exceeding a threshold idle time.

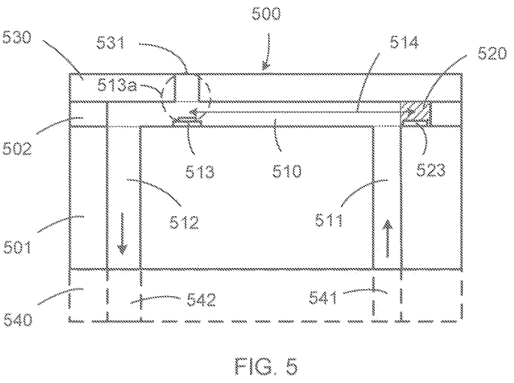

Referring now to FIG. 5, a printing fluid ejection assembly 500 is shown. The printing fluid assembly 500 comprises a series of layers stacked on each other, wherein each of the layers comprises an aperture (or apertures) so that the stacked layers form printing fluid channels of the printing fluid ejection assembly 500. In particular, the printing fluid ejection assembly 500 of FIG. 5 comprises a substrate layer 501 comprising a printing fluid inlet 511 and a printing fluid outlet 512, a printing fluid chamber layer 502, and a nozzle layer 530 comprising a nozzle 531 arranged to correspond to a printing fluid ejection element 513.

In FIG. 5, the printing fluid chamber layer 502 is arranged between the substrate layer 501 and the nozzle layer 530. The printing fluid chamber layer 502 of the printing fluid ejection assembly 500 comprises a first channel 510 to fluidly connect the printing fluid inlet 511 to the printing fluid outlet 512, wherein the first channel 510 comprises the printing fluid ejection element 513. In addition, the printing fluid chamber layer 502 further comprises a second channel 520 in fluidic communication with the printing fluid ejection element 513, wherein the second channel 520 comprises an actuator 523 at a distance with respect to the printing fluid ejection element 523 such that a fluid path 514 is defined from the actuator 523 to the printing fluid ejection element 513. The actuator 523, in response to a refresh signal, is to generate a pressure pulse to refresh the printing fluid located at a meniscus region 513a associated with the nozzle 531.

In use, the printing fluid inlet 511 receives printing fluid from a first printing fluid line 541 of a printing fluid supply system 540 and the printing fluid outlet 512 is to output printing fluid to second printing fluid line 542 of the printing fluid supply system 540. Then, the printing fluid flows through the first channel 521 and the second channel 520. In some examples, the second channel 520 may comprise a closed end. In some other examples, the second channel 520 may be fluidly connected to multiple regions of the first channel 510. Then, when the printing fluid assembly is to dispense printing fluid droplets out of the nozzle 531 of the nozzle layer 530, the printing fluid ejection element 513 is fired. As a result of the firing, printing fluid from the first channel 510 is ejected, and additional printing fluid is supplied by the first printing fluid line to the first channel 510 via the printing fluid inlet 511.

In some examples, the actuator 523 may be positioned with respect to the printing fluid ejection element 513 at a distance within a range of admissible distances. In some examples, the range of admissible distances may be based on geometries of fluid path 514 defined from the actuator 523 to the printing fluid ejection element 513. In some examples, the range of admissible distances at which the actuator 523 has to be positioned with respect to the printing fluid ejection element 513 to effectively refresh the nozzle meniscus region(s) may be associated with a printing fluid ejection assembly lumped parameter. In other examples, the range of admissible distance may be associated with a printing fluid ejection assembly lumped parameter and an actuator ratio.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims (and their equivalents) in which all terms are meant in their broadest reasonable sense unless otherwise indicated.

1. A printing fluid ejection assembly comprising:
a first printing fluid channel comprising:
an inlet to receive printing fluid,
an outlet to output printing fluid, and
a first printing fluid ejection element between the inlet and the outlet;
a second printing fluid channel arranged with respect to the first printing fluid channel, the second printing fluid channel comprising an actuator in fluidic communication with the first printing fluid ejection element of the first printing fluid channel; and
a nozzle layer comprising a first nozzle arranged to correspond to the first printing fluid ejection element of the first printing fluid channel,
wherein the actuator is arranged with respect to the first printing fluid ejection element such that, in response to reception of refresh signals, the actuator is to fire and refresh printing fluid in a first nozzle meniscus region.

2. The printing fluid ejection assembly of claim 1, wherein the actuator is in fluidic communication with the first printing fluid ejection element via at least one of an inlet region associated with the inlet and an outlet region associated with the outlet.

3. The printing fluid ejection assembly of claim 1, wherein the actuator is arranged at a distance with respect to the first printing fluid ejection element based on a printing fluid ejection assembly lumped parameter associated with the geometries of the first printing fluid channel and the second printing fluid channel.

4. The printing fluid ejection assembly of claim 3, wherein the distance between the actuator and the first printing fluid ejection element is within a range of distances associated with a printing fluid ejection assembly lumped parameter range from 0.0001 μm³ to 0.003 μm⁻³.

5. The printing fluid ejection assembly of claim 1, wherein the nozzle layer further comprises a second nozzle arranged to correspond to a second printing fluid ejection element, the assembly further comprising:
a third printing fluid channel arranged with respect to the first printing fluid channel and the second printing fluid channel, the third printing fluid channel comprising the second printing fluid ejection element in fluidic communication with the actuator,
wherein the actuator is arranged with respect to the second printing fluid ejection element such that, in response to reception of refresh signals, the actuator is to fire and refresh printing fluid in a second nozzle meniscus region and the first nozzle meniscus region.

6. The printing fluid ejection assembly of claim 5, wherein the actuator in fluidic communication with the first printing fluid ejection element and the second printing fluid ejection element via an inlet region, an outlet region and a series of parallel channels, wherein the actuator is arranged with respect to each of the first printing fluid ejection element and the second printing fluid ejection element based on geometries of the series of fluid paths.

7. The printing fluid ejection assembly of claim 6, wherein the first printing fluid path is in fluidic with the third printing fluid path via the inlet region and the outlet region and the second printing fluid path is in fluidic communication with the first printing fluid path and the second printing fluid path via the series of parallel channels.

8. A method for refreshing printing fluid, the method comprising:
receiving a refresh signal associated with a refreshing operation in a printing fluid ejection assembly comprising a first printing fluid channel, the first printing fluid channel comprising a printing fluid inlet, a printing fluid outlet, and a first printing fluid ejection element arranged to correspond to a first nozzle; and
in response to the refresh signal, refreshing printing fluid with a non-ejecting impulse generated by an actuator positioned in a second printing fluid channel in fluidic communication with the first printing fluid ejection element of the first printing fluid channel,
wherein the non-ejecting impulse refreshes the printing fluid at a first meniscus region associated with the first nozzle.

9. The method of claim 8, the method further comprising:
calculating an ejection idle time associated with the fluid ejection element; and
upon the ejection idle time exceeds a threshold idle time, performing a subsequent refreshing operation with the actuator.

10. The method of claim 8, wherein determining the non-ejecting impulse generated by the actuator is based on a first printing fluid channel geometry, a second printing fluid channel geometry, and a series of fluid paths from the actuator to the printing fluid ejection element.

11. A printing fluid ejection assembly comprising:
a substrate layer comprising a printing fluid inlet and a printing fluid outlet;
a printing fluid chamber layer comprising:
a first channel to fluidly connect the printing fluid inlet to the printing fluid outlet, the first channel comprising a printing fluid ejection element, and a second channel in fluidic communication with the printing fluid ejection element, the second channel comprising an actuator at a distance with respect to the printing fluid ejection element; and
a nozzle layer comprising a nozzle arranged to correspond to the printing fluid ejection element,
wherein the printing fluid chamber layer is arranged between the substrate layer and the nozzle layer, wherein the actuator is to generate a pressure pulse to refresh the printing fluid located at a meniscus region associated with the nozzle.

12. The printing fluid ejection assembly of claim 11, wherein the first channel and the second channel are fluidly connected via an inlet region associated with the inlet and an outlet region associated with the outlet.

13. The printing fluid ejection assembly of claim 11, wherein the distance between the actuator and the printing fluid ejection element is within a range of distances based on geometries of fluid paths from the actuator to the printing fluid ejection element.

14. The printing fluid ejection assembly of claim 13, wherein a cross-sectional area of the second channel is lower than a cross-sectional area of the first channel.

15. The printing fluid ejection assembly of claim 13, wherein the range of distances is associated with a printing fluid ejection assembly lumped parameter range from 0.0001 μm⁻³ to 0.003 μm⁻³ and an actuator ratio within a range from 20 000 μm⁵ to 800 000 μm⁵.
